(19) United States
(12) Patent Application Publication
(10) Pub. No.: US 2014/0142971 A1
(43) Pub. Date: May 22, 2014

(54) Automated Prescription Renewal System, Process, Method, Computer and Communications Device

(71) Applicant: Prokopios Panagakos, Boca Raton, FL (US)

(72) Inventor: Prokopios Panagakos, Boca Raton, FL (US)

(21) Appl. No.: 14/085,439

(22) Filed: Nov. 20, 2013

Related U.S. Application Data
(60) Provisional application No. 61/729,305, filed on Nov. 21, 2012.

(51) Int. Cl. G06F 19/00

(52) U.S. Cl. CPC G06F 19/3456
USPC 705/2

(57) ABSTRACT

An efficient solution for the renewal of prescriptions for pharmacies, pharmacists, doctors and patients that automatically requests a prescription renewal from a prescribing doctor when a patient requests medications that have expired, are lost, or for which there are no more refills left.

### CROSS-REFERENCE TO RELATED APPLICATIONS

This application claims the benefit of U.S. Provisional Application for Patent No. 61/729,305 entitled Automated Prescription Renewal System, Process, Method, Computer and Communications Device, filed on Nov. 21, 2012, which is incorporated by reference herein in its entirety.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to a system, method, computer and communications device for automating the process of renewing a prescription when a prior prescription has expired or been exhausted.

2. Description of the Related Art

Pharmacies and pharmacists often receive requests from patients or doctors to refill prescriptions that have expired or for which the customer has no more refills remaining Prior to the instant invention this would require the pharmacist or the pharmacist's staff to call the prescribing doctor to ask if the doctor would reissue the prescription.

### SUMMARY OF THE INVENTION

The present invention overcomes problems with the prior art by automating the request from the patient to the pharmacist and by having the patient's request directly routed by a computer to the prescribing doctor. End users can use their smart phones, mobile devices, Internet connections, telephones, or other communication devices to initiate a request for prescription renewal. If the patient calls the pharmacy or pharmacist, the pharmacy/pharmacists may also use the system for the patient to avoid error and searching for information in multiple locations. The system benefits the patient, the pharmacy, the pharmacy staff, the doctor and the doctor's staff by minimizing phone calls and manual transactions that expend time and waste resources.

The system also removes human error by assuring the proper protocols are followed.

Although the invention is illustrated and described herein as embodied in an automated prescription renewal system, process, method and computer and communications device, the invention is not limited to the details shown because various modifications and structural changes may be made without departing from the invention and the equivalents of the claims. However, the construction and method of operation of the invention together with additional objects and advantages thereof will be best understood from the following description of specific embodiments when read in connection with the accompanying drawings.

### BRIEF DESCRIPTION OF THE DRAWINGS

FIG. 1 is a flowchart showing an overview of the steps of an embodiment of the system to automate a patient's request for a prescription renewal placed with a pharmacy.

FIG. 2 is a front view showing one possible user interface for the instant invention.

FIG. 3 is a front view showing another possible user interface for the instant invention.

FIG. 4 is a front view showing another possible user interface for the instant invention.

FIG. 5 is a diagram showing an overview of a computer system embodiment of the instant invention.

### DETAILED DESCRIPTION OF THE INVENTION

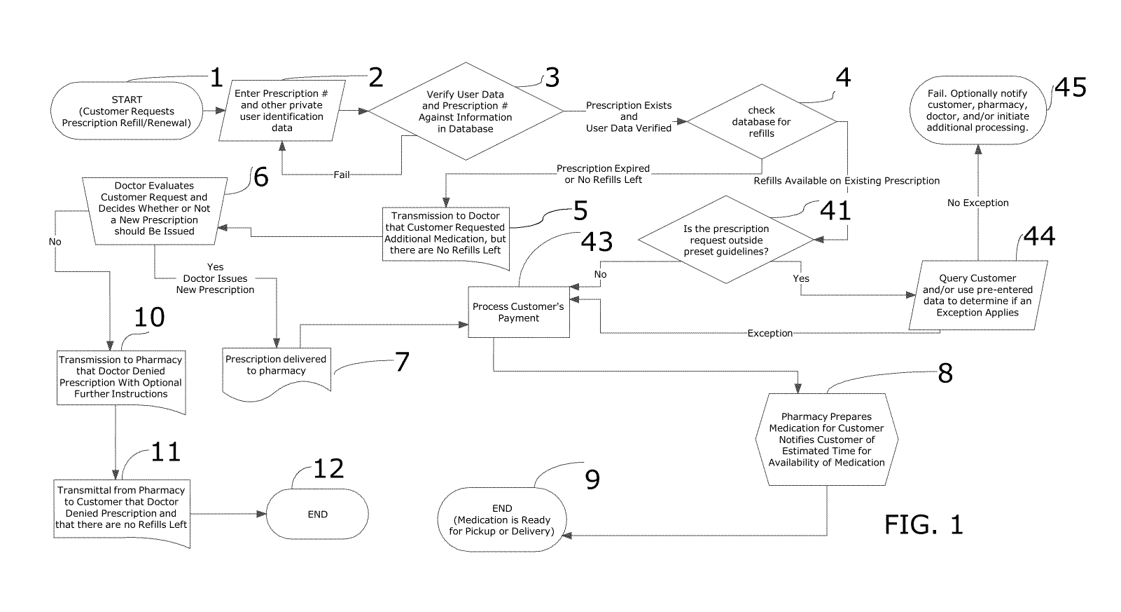

Referring to the drawings, FIG. 1 shows a flow chart of the system, process and method of the instant invention. In step one (1), the end user, typically a patient, pharmacist, or pharmacy staff member, requests a prescription refill request (20). A refill request includes a renewal of an existing prescription. In step (2), the user enters the patient's prescription number (14), and in example embodiments, additional personal identifying information such as the patient's date of birth (15) is entered on user interface (19) and the customer selects go (16) to advance to the next step.

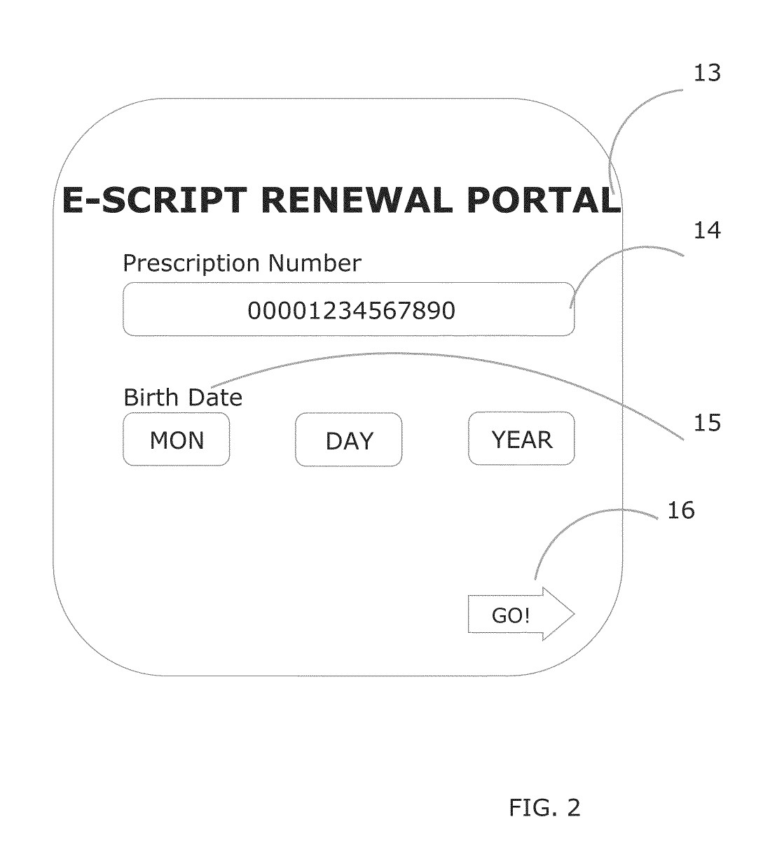

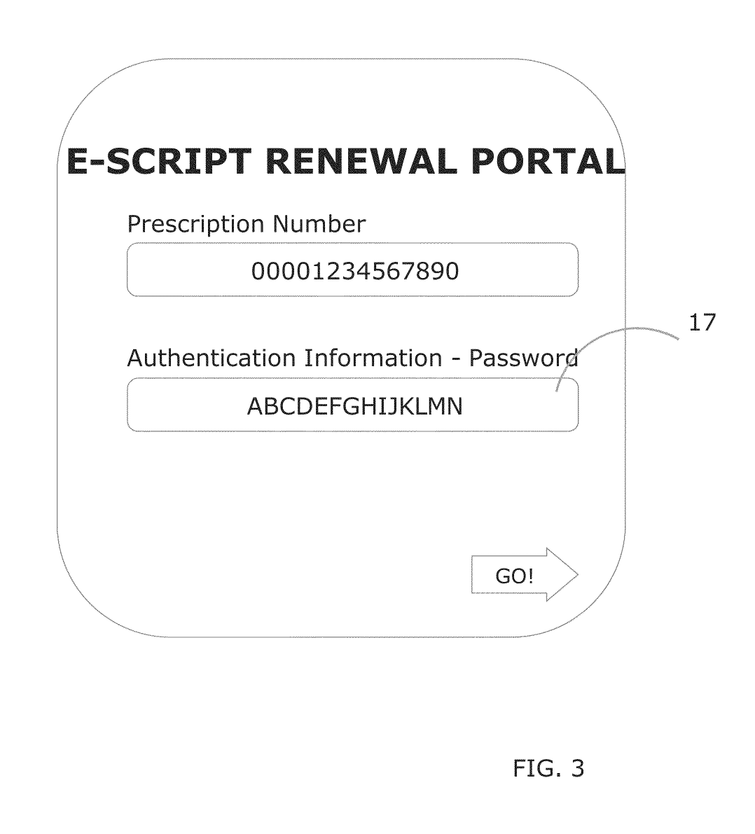

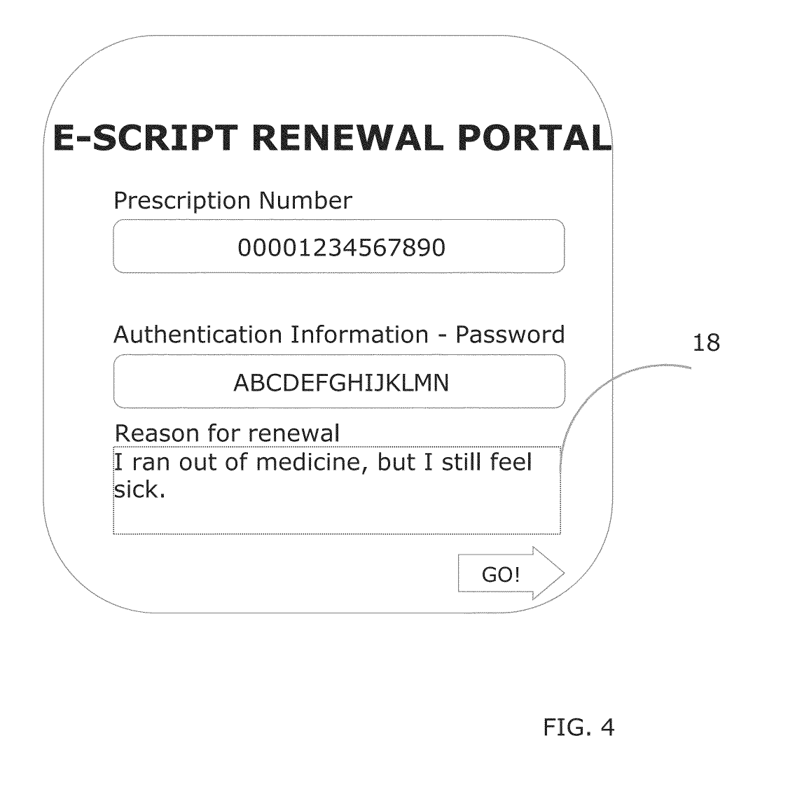

FIGS. 2 and 3 show example embodiments of different user interfaces (19) for inputting the information, such as a password (17) and date of birth (15). Other and or additional personally identifying and/or authenticating information, including, but not limited to a patient's mother's maiden name, phone number, driver's license number, e-mail address, social security number, insurance identification number, password, passport, fingerprint, retinal signature, hand signature, voice signature, phone identification, account login, etc. may be used for identification/authentication purposes and may substitute or supplement for the date of birth (15) and/or password (17). The customer may also enter additional information indicating the renewal reason (18). Some embodiments of the invention are entirely voice controlled and authenticated through voice signatures and do not require an interface such as those described in FIGS. 2, 3, 4, and 5. The figures are for illustrative purposes and are not intended to limit the scope of the invention as to any particular embodiment. The system also optionally identifies itself to the end user through a trade name or trademark as shown in title element (13).

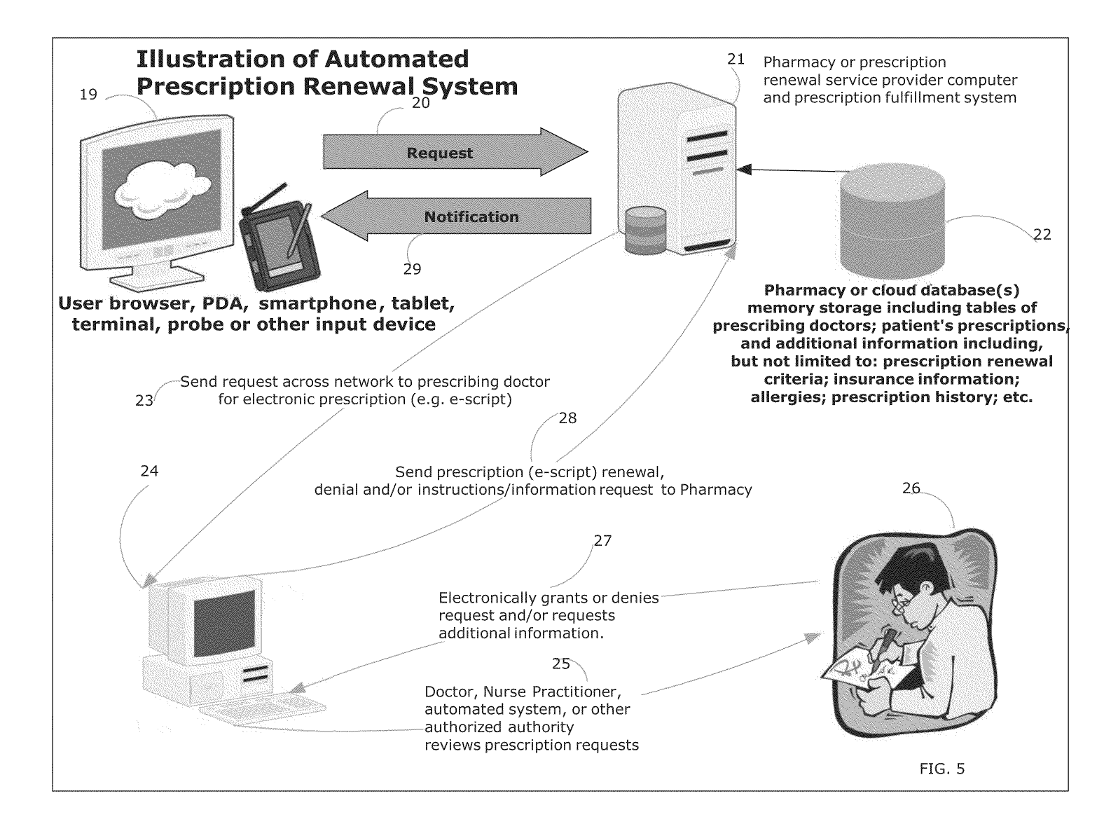

In step (3), the personally identifying information is used by the user terminal or preferably pharmacy or prescription service provider computer and prescription fulfillment service (21) shown in FIG. 5 to verify the identity of the requesting patient, and confirm and identify the prescription that the patient is requesting renewed. Data and information required by the system for verification is stored in any manner including, but not limited to, computer memory, data files, cloud storage and/or a relational database management system. The verification is performed by looking up and/or comparing the user prescription and/or patient information with that stored in the pharmacy, service provider, and/or database (22). Examples of databases (22) include, but are not limited to, cloud storage, memory storage, and servers.

If the verification fails, the user is returned to step (2), or another alternative step, such as an alert or notice of failure. In example embodiments, a message or log of unauthorized attempts is created or sent to designated persons, through, by way of example: email; voice message; Short Message Service; and/or, other paging methods known in the art.

If the patient's identity and prescription number (14) are verified then in step (4), the system checks to see if any refills are available, based upon the database (22). A remaining refill means that at least one refill remains on the prescription and that the prescription did not expire.

After step (2), and preferably after step (3), the system may also check to see if the prescription number (14) is renewable in step (4), or request additional information depending on the medication requested and legal requirements. If a refill is available on existing prescription number (14), the system proceeds to step (41) and determines if the prescription is outside preset guidelines. If the refill reason provided by the customer is within guidelines, such as time between successive refills, the pharmacy in step (43) notifies the customer of the refill price and processes the customer's payment. Approval by the prescribing doctor (26) is not required when a refill request falls within preset guidelines. When the customer's request falls outside preset guidelines, the system proceeds to step (44) and queries the customer for a reason for the prescription refill. If an exception does not apply to preset guidelines, the system proceeds to step (45) where the customer, pharmacy, and/or prescribing doctor is notified of the failed exception and provides additional processing, if necessary.

When the prescription request is outside of preset guidelines, the system in step (44) queries the customer for a reason for the prescription refill. If the customer's reason for the refill exception satisfies preset guidelines, the system proceeds to step (43) for payment processing.

Upon successful payment in step (43), the system notifies the pharmacy in step (8) of the prescription renewal (28) so the pharmacy prepares the prescription refill and determines timing for preparation of the refill. The pharmacy notifies the customer of the estimated time for the prescription's availability. In step (9), the prescription is ready for pickup or delivery. The pharmacy includes the pharmacist, pharmacy staff, and any other personnel involved in refilling a prescription. In example embodiments, the system interfaces with an automated prescription fulfilling or dispensing machine.

In additional exemplary embodiments of the system, after step (3) the invention either: 1) prompts the user whether or not they would like to request a renewal through their physician; or, 2) foregoes the request. In some embodiments of the invention, the invention also automatically contacts the physician as in step (5) without any further prompt or input from the end user.

In an example embodiment, when a refill request is made outside of standard guidelines, e.g., the prescription is being refilled too early, the instant invention contacts the user to determine why the user is requesting an additional refill early. The user responds with a reason for the early refill, such as leaving on a trip where access to medication is limited or a prolonged business trip. In an alternative embodiment, the user can specify the special circumstances of why they are renewing too early so that the system does not need to prompt them. Providing this information with a request for a refill to the prescribing doctor, the instant invention will reduce the time to receive a decision from the pharmacy or prescribing doctor regarding the refill.

When the prescription has expired or there are no refills left after checking database (22) in step (4), the system in step (5) automates a communication (23), or transmission, to the prescribing doctor (26), which is optionally the original prescribing doctor or another substitute prescribing doctor (26). The notification informs the prescribing doctor (26) that the patient requested a prescription renewal in step (5) but no refills remain on the prescription. The prescribing doctor (26) referenced in the instant invention also includes other medical personnel, such as other doctors, physician's assistants, and other personnel with prescription writing authority.

The notification in step (5) may be communicated (23) to the prescribing doctor (26) by email, computer network, a computer with a processing module, telephone, facsimile, radio, microwave or other types of communication common in the industry. In the preferred embodiment, the request informs the prescription, patient and pharmacy. In example embodiments, additional information such as patient age, sex, height, weight, body mass index (BMI), prescription history, insurance information, and/or current prescriptions status is also communicated to the prescribing doctor (26). Additionally, in some embodiments the system prompts users for additional information regarding their symptoms supporting their request for a prescription renewal in step (5). Any of this additional information can be retrieved and/or stored in a database (22) and/or is gathered through the user interface after step (1) and preferably, but not necessarily, after step (4).

Other additional information, including but not limited to image, biothermal, heat, blood sugar, pH, blood cell count, blood pressure, pulse, hearbeat, air quality, and/or other biometric/environmental data is optionally relayed to the prescribing physician through optional sensors and probes intergated in or attached to the end user's communication device/kiosk.

Additionally, automated questionairres, database profiles and probes may detect and inform the prescribing doctor if the end user has any allergies.

After retrieval from the database or by any various methods of user input, the additional information is communicated (23) to the prescribing doctor (26) and optionally to the pharamcist. The additional information can then be reviewed (25) by the prescribing doctor (26) in determining whether or not to reissue additional medication or require a telephonic consultation or an office visit. Some information is optionally used by the prescribing doctor (26) to verify user input and/or that a continued prescription would be favorable for the user or that other action is needed. For instance, the prescribing doctor could compare user symptoms with those reported by probes on the end user's communication device.

The doctor is identified by the system by various means such as by license number, facsimile number, phone number, address, National Provider Identification (NPI), Drug Enforcement Agency (DEA), uniquely assigned serial number, code, or other unique indentifying information. This information is optionally stored in a database (22), such as a pharmacy databse, a doctor's database, and/or other third party data and/or service providers.

After step (5), the prescribing doctor (26) evaluates the user's request in step (6) and either issues a prescription renewal or denial (27). When the prescribing doctor (26) issues a new prescription, the decision is then transmitted across a communications network back to the pharmacy (28), step (7). Once received by the pharmacy (26), the system requests payment from the user in step (43). The payment, typically in the form of a credit card or bank card, is made by the user and submitted using an electronic signature. Payment options include, but are not limited to, credit card, PAYPAL, automated clearing house (ACH) and/or other systems commonly used to submit electronic payments.

Once payment is completed, the pharmacy prepares the prescription in step (8) and notifies (29) the user of estimated timing for completion. In step (9), the prescribed medication is available for pickup or delivery depending on the customer's request or pharmacy policy.

When the prescription renewal (28) is denied in step (6), the prescribing doctor (26) informs the pharmacy in step (10) of the denial and provides optional instructions, if necessary. The pharmacy then informs the customer in step (11) that the prescribing doctor denied the prescription and that no refills remain. Step (12) ends the prescription renewal attempt.

Depending on legal constraints and the medicine requested, in some or all cases, the doctor's approval may be automated by a prescribing machine, which could be operated by standard policies or configured by the prescribing doctor or equivalent, such as an industry standard organization/policy. Optionally, a notification automatically advises the pharmacy customer that their prescription is ready, or based upon time tables and/or other heuristics about to be ready, for pick up or has been sent out for delivery.

What is claimed is:

1. A system for renewing a prescription, comprising:
a user interface to enter a prescription;
a database for storing said prescription and user data;
a means to check said prescription in said database to determine remaining refills for said prescription;
said user interface reports that additional refills require medical authorization when all refills are exhausted; and
medical personnel communicate to a pharmacy, wherein:
said medical personnel approves the refill of said prescription; or
said medical personnel denies the refill of said prescription.

2. The system recited in claim 1, further comprising:
said pharmacy requests approval from said medical personnel for said refill through said user interface;
medical personnel provide approval for said refill through said user interface;
notifying a user to submit payment through said user interface;
a means to submit payment using said interface; and
said pharmacy prepares said refill.

3. The system recited in claim 1, wherein said pharmacy requests approval from said medical personnel for said refill through said user interface.

4. The system recited in claim 1, further comprising a means to submit payment to said pharmacy with said user interface.

5. The system recited in claim 1, further comprising preset guidelines for approved refill requests.

6. The system recited in claim 1, further comprising:
a computer with a processing module, wherein said prescription is matched to said medical personnel in said database; and
said processing module requests a prescription renewal to said medical personnel when all refills are exhausted.

7. The system recited in claim 1, wherein said user interface includes at least one of the following: a tablet, smart phone, computer browser, and computer terminal.

8. The system recited in claim 1, further comprising a means to authenticate a user requesting said refill using said user interface and said database.

9. The system recited in claim 1, further comprising:
a log to track user authentication attempts; and
a means to communicate failed authentication attempts to designated user.

10. The system recited in claim 1, further comprising:
approval from medical personnel for additional refills; and
an automated prescription dispensing machine to deliver said prescription to said user.

11. The system recited in claim 1, wherein communication from pharmacy to said doctor using said user interface for prescription approval when all refills are exhausted includes at least one of the following: prescription number, patient name, pharmacy identifier, patient age, sex, height, weight, body mass index (BMI), prescription history, insurance information, and prescriptions status.

12. A method for renewing a prescription, comprising:
checking a database for remaining refills for a prescription through a user interface;
requesting approval from medical personnel for a refill of said prescription by a pharmacy through said user interface;
obtaining approval from said medical personnel for said refill of said prescription through said user interface; and
preparing said refill for a user.

13. The method recited in claim 12, further comprising:
matching said prescription with said medical personnel using a computer processing module and said database; and
requesting a prescription renewal using said computer processing module to said medical personnel when all refills are exhausted.

14. The method recited in claim 12, furthering comprising notifying said user that said refill is complete.

15. The method recited in claim 12, furthering comprising submitting payment for said refill through said user interface.

16. The method recited in claim 12, further comprising:
comparing a refill reason to preset guidelines in said database;
preparing refill when said refill reason is within said preset guidelines; and
denying refill when said refill reason is outside said preset guidelines.

17. The method recited in claim 12, further comprising authenticating said user requesting said refill using said user interface and said database.

18. The method recited in claim 12, wherein said database includes at least one of the following: cloud storage, memory storage, and a server.

19. A method for renewing a prescription, comprising:
checking a database for remaining refills for a prescription through a user interface;
requesting approval from medical personnel for a refill of said prescription by a pharmacy through said user interface;
obtaining a denial from said medical personnel for said refill of said prescription through said user interface; and
informing said user that medical personnel denied said refill request using said user interface.

20. The method of renewing a prescription as recited in claim 19, further comprising authenticating said user requesting said refill using said user interface and said database.
